(19) United States
(12) Patent Application Publication
(10) Pub. No.: US 2013/0182081 A1
(43) Pub. Date: Jul. 18, 2013

(54) Real-Time Stereo 3D Digital/Video Imaging in a Light Microscope Using a Single Lens and a Single Camera

(71) Applicant: Gary Greenberg, Paia, HI (US)

(72) Inventor: Gary Greenberg, Paia, HI (US)

(21) Appl. No.: 13/737,265

(22) Filed: Jan. 9, 2013

Related U.S. Application Data
(60) Provisional application No. 61/631,927, filed on Jan. 12, 2012.

(51) Int. Cl. H04N 13/02

(52) U.S. Cl. CPC H04N 13/0207
USPC 348/49

(57) ABSTRACT

The methods and apparatus of the present invention provide 3D real-time viewing in a light microscope by passing light through only a portion of the objective aperture, in such a way as to produce alternating left-eye and right-eye views of the specimen. A computer with a sync pulse generator synchronizes the frame rate of the camera with the alternating left-eye and right-eye images, which are sequentially captured by the camera and reformatted into the standard side-by-side stereo file format and displayed on a 3D TV or the like, where they can be viewed in 3D in real-time.

### FIELD OF THE INVENTION

The present invention relates to microscopes and, more particularly, to methods and apparatus for producing automated 3D images in a light microscope using a computer, shaped light beams, a single camera, and a single objective lens.

### BACKGROUND OF THE INVENTION

Microscope specimens are three-dimensional objects, but standard light microscopes produce only two-dimensional images. Information is lost and misinterpretation occurs when viewing two-dimensional images of three-dimensional objects.

### SUMMARY OF THE INVENTION

It is known that in a standard 2D microscope optical system, the pupil of the eyepiece, the back focal plane of the condenser lens and the illumination bulb are optically conjugate to the back focal plane of the objective lens (Koehler illumination in a transmitted light microscope).

The methods and apparatus of the present invention function by sequentially creating alternating left-eye and right-eye views of a specimen at a rate that is synchronized with the frame rate of the camera whereby alternating left-eye and right-eye images of the specimen are sequentially captured by the camera. The alternating left-eye and right-eye images are reformatted into the standard side-by-side stereo file format and are sent to a 3D display system, such as a 3D TV, where they can be viewed in 3D in real-time.

While the prior art teaches how to provide direct-view 3D imaging using a single lens with two cameras by employing a pyramid mirror to dissect out the left and right images at the conjugate aperture plane located at the pupil of the eyepiece (Greenberg G, U.S. Pat. No. 6,020,993), using two cameras increases the cost and complexity of the system and requires precise moving parts to register and align the left and right cameras. The present invention is able to provide real time 3D viewing using only a single camera, thereby achieving perfect registration of left and right images that can be automatically maintained to a resolution of one pixel.

In the present invention, the left-eye and right-eye views are synchronized with the timing of the exposure of the frames (frame rate) in a digital/video camera. A 3D output unit sorts the alternating left and right images and immediately processes them to be displayed in real-time on a 3D TV or 3D monitor and/or saved in a 3D file format that can be used by standard 3D display systems.

The method of the invention for creating 3D perception of a three-dimensional specimen using a microscope having a single objective lens with an objective aperture having an aperture area, a single camera having a frame rate, and an illumination system that directs light along an optical path that includes the specimen, the objective aperture and the camera comprises: creating a right-eye view of the specimen in the camera by limiting the light that passes through the objective aperture to less than the entire area of the objective aperture; creating a left-eye view of the specimen in the camera by limiting the light that passes through the objective aperture to less than the entire area of the objective aperture which is a different area (although may have overlapping areas) than that which creates the right-eye view; alternatively creating left-eye views and right-eye views at a rate that is a function of the camera frame rate. The microscope apparatus of the invention for creating 3D perception of a three-dimensional specimen having a single objective lens with an objective aperture having an aperture area, and a single camera having a frame rate comprises: an illumination system that, in a first mode of operation, directs light along an optical path that includes the specimen, the objective aperture and the camera and only passes light through a portion of the objective aperture to create a right-eye view of the specimen, and in a second mode of operation, directs light along a path that includes the specimen, the objective aperture and the camera and only passes light through a different portion of the objective aperture (which may include some overlapping) to create a left-eye view of the specimen.

### DESCRIPTION OF THE DRAWINGS

FIG. 1 is a schematic illustration showing one embodiment of the invention in the context of a microscope optical system;

FIG. 2A is a schematic illustration showing a mechanical embodiment of the invention in a microscope optical system;

FIG. 2B is a plan view of the mask disc of the invention of FIG. 2A in one orientation;

FIG. 2C is a plan view of the mask disc of the invention of FIG. 2A in an other orientation;

FIG. 3 is a schematic illustration showing another embodiment of invention in a microscope optical system; and

FIG. 4 is a possible graphical user interface for a computer that controls the operation of the invention.

### DETAILED DESCRIPTION OF THE INVENTION

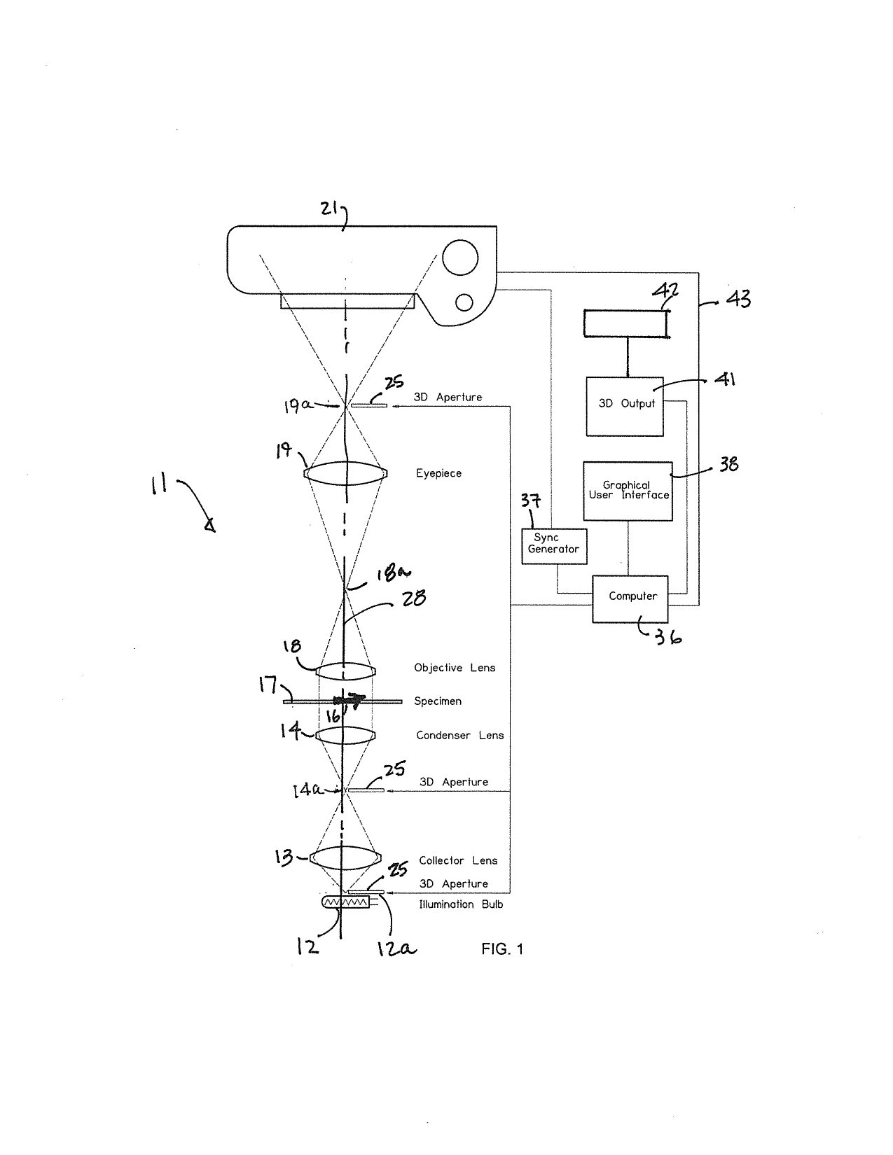

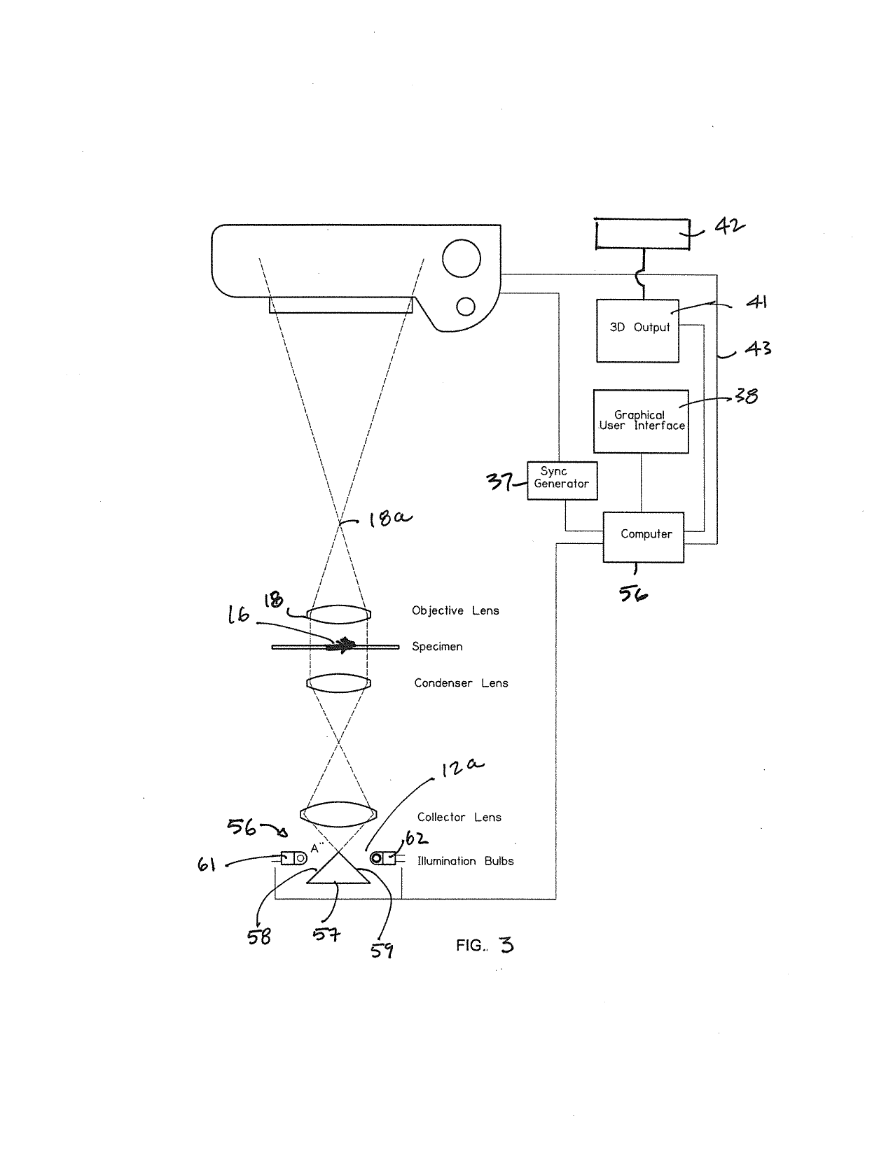

FIGS. 1 and 3 illustrate the invention in a fixed tube length microscope optical system; however, those skilled in the art will recognize that an infinity tube length system would work in a similar way, but with the addition of an infinity tube lens positioned after the infinity objective lens.

Referring to FIG. 1, a microscope optical system 11 comprises an illuminator 12 which, for purposes of illustration, is shown as a light transmitting bulb with the understanding that other light transmitting devices are also included, a collector lens 13, a condenser lens 14, a specimen 16 at a specimen plane 17, an objective lens 18, an eye piece 19, and a viewing device such as a camera 21 all aligned along an optical path 28.

There are three potentially accessible locations along the optical path 28 where a mechanical aperture mask 25 could be located including: (1) the pupil 19a of the eyepiece 19, which has the advantage of being compatible with any method of illumination, such as reflected illumination, transmitted illumination or fluorescence illumination; (2) the back focal plane 14a of the condenser lens 14, which has the advantage of increasing resolution, depth of field and contrast, but has the restriction of being compatible only with transmitted light systems; and (3) the illuminator 12, which also has the disadvantage of being compatible with transmitted light only, and also has the disadvantage of being in a location that can be at an elevated temperature which could effect a mechanical device.

A mask 25 (which, in the present invention, resides only at one of the three conjugate planes 12a, 14a or 19a, is shown at all three possible locations simply to illustrate all of the possibilities) prevents light from passing through a portion of the aperture at any of the three conjugate planes 12a, 14a or 19a where it is disposed. It may be necessary to include the eye piece 19 in an optical system without one in order to create the optimum location for placement of the aperture mask 25.

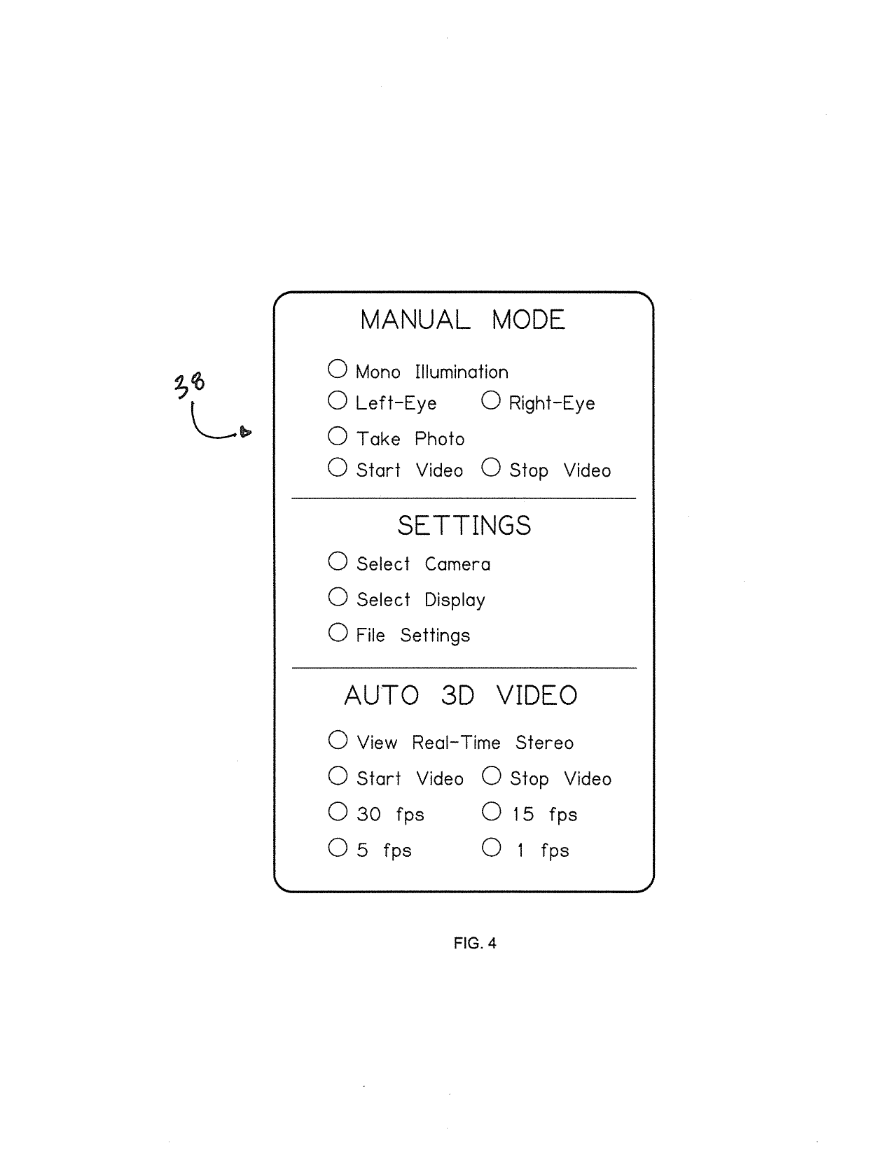

A computer 36 is operatively connected to the aperture mask 25 and digital/video camera 21 via a synchronization module (sync generator) 37. The computer 36 is also connected to the camera 21 via an in/out connection line 43 by which the computer 36 controls the various camera functions and retrieves images from the camera 21 to the computer 36. The computer 36 is controlled by a user-friendly graphical user interface (GUI) 38 (see FIG. 4).

A synchronizing (“sync”) signal is used to coordinate the actions of the camera 21 and the aperture mask 25. A sync signal generated by the computer 36 (or other sync signal generator) synchronizes the camera frame rate with the rate at which the left-eye/right-eye views (images) are alternated. Where the camera 21 generates a sync signal of its own, that signal can be used as the sync generator 37.

In this preferred embodiment of the invention, left-eye and right-eye images are alternately captured by the single camera 21 on alternate frames. This alternation (or oscillation) can be set at standard video rate (i.e. 30 Hz) or another rate determined by the user. These images are sent to computer 36, which sends them to a 3D output unit 41 to sort the left-eye images and right-eye images into the standard side-by-side 3D file format where they are sent to a display unit 42 that can be one of several known systems such as a 3D TV or a 3D-ready monitor.

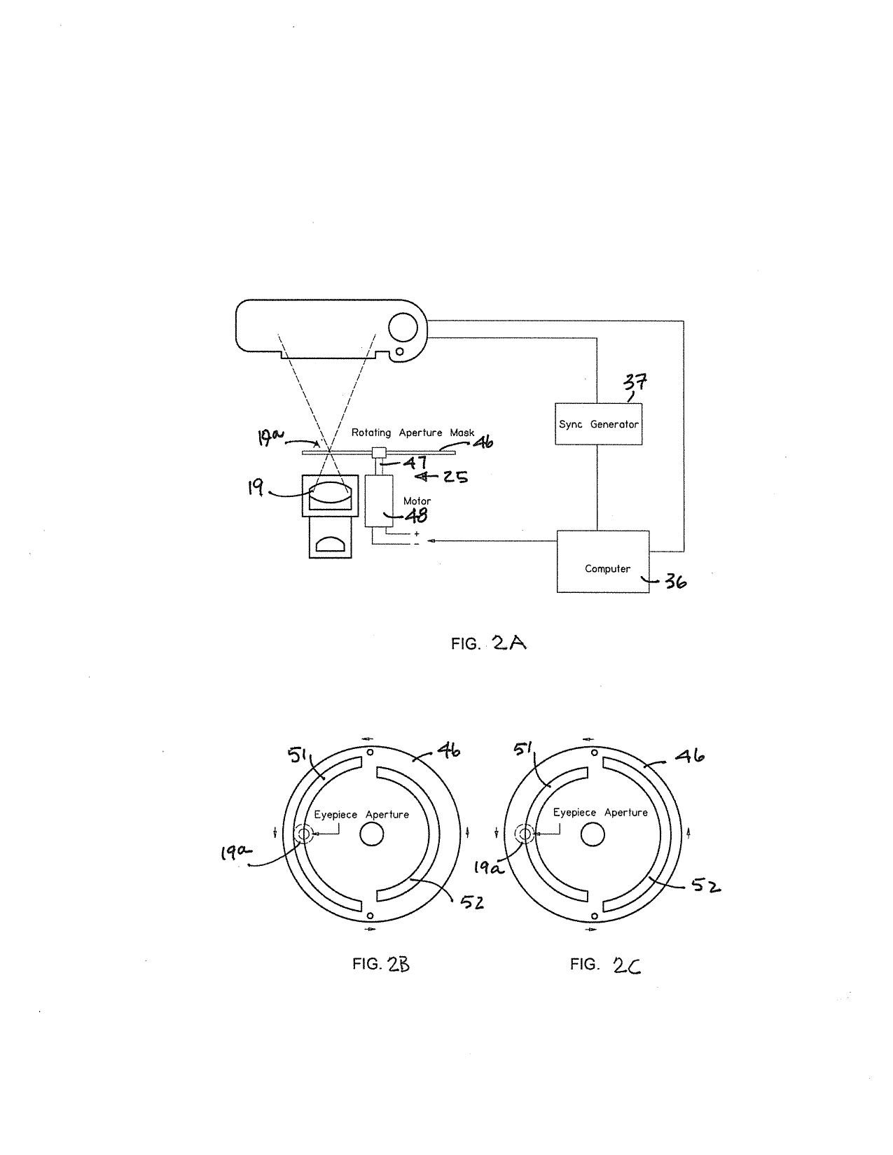

Referring to FIGS. 2A, 2B and 2C, a mechanical aperture mask 25 comprises a specially perforated opaque disk 46 that is mounted on a shaft 47 for rotation by a motor 48 that is controlled by computer 36. The disc 46 is shown located at the back focal plane aperture (pupil) 19a of the eye piece 19 (although it could also be disposed at the other locations described above) whereupon, during one segment of its rotation, it obscures a portion (e.g., one-half) of the aperture 19a and, during another segment of its rotation, it obscures another portion of the aperture 19a. A first semi-circular slot 51 and a second semi-circular slot 52 in opaque disc 46 are positioned to perform the function of allowing a portion (but only a portion) of the illumination to pass through the aperture 19a when disc 46 is rotated. The speed of motor 48 that rotates the disk 46 is controlled by the computer 36 and sync generator 37 so that while the left-eye view is being recorded in the camera 21, the rotating disk 46 is blocking the light at the right side of the aperture 19a, as shown in FIG. 3B. When the next frame is being exposed, the rotating disk will have progressed to the position shown in FIG. 3C and the right-eye view is recorded, and so on and so forth, repeatedly. Other mechanical and electrical mask systems that alternatively produce a right-eye view and a left-eye view are possible and could produce the same result.

The illuminator 12, mask 25, sync generator 37 and computer 36 comprise the illumination system of this embodiment of the invention that has two modes of operation. In a first mode of operation, light from illuminator 12 is directed along the optical path 28 that includes the specimen 16, the objective aperture 18a and the camera 21 and only passes light through the unmasked portion of the objective aperture to create a right-eye view of the specimen. In a second mode of operation, light from illuminator 12 is directed along the same optical path and only passes light through a different (including overlapping) unmasked portion of the objective aperture to create a left-eye view of the specimen.

As an alternative to a mechanical mask device 25 such as that described above where the aperture 19a is fully illuminated but partially blocked (masked) to allow only a portion of the light to be pass through the aperture 19a to the recording device (camera 21), is a system where the aperture is not masked but, instead, only a portion of the aperture is illuminated. Because this embodiment of the invention does not require a mechanical device to be inserted in the optical path, it is not necessary to add an eye piece to those systems that do not use one.

Referring to FIG. 3, an illuminator 56 replaces the bulb 12 (FIG. 1) at conjugate aperture 12a and comprises a mirror 57 having two angled reflection surfaces (mirrors) 58 and 59. Illumination sources (lights) 61 and 62 are disposed to illuminate first and second mirror surfaces 58 and 59, respectively. Light reflected from first mirror surface 58 only partially fills one portion of the objective aperture 18a of the objective lens 18 (one-half, for example), while light reflected from second mirror surface 59 only partially fills another portion of the aperture 18a of the objective lens 18 whereby right- and left-eye views of a specimen 16 are viewed by camera 21. The lights 61 and 62 are controlled by computer 36 to be turned on and off in synchronization with the frame rate of the camera 21 as described above.

The illuminator 56 (lights 61 and 62 and mirrors 58 and 59), comprise the illumination system of this embodiment of the invention that has two modes of operation. In a first mode of operation, light from illuminator 12 is directed along the optical path 28 that includes the specimen 16, the objective aperture 18a and the camera 21 and only passes light through a portion of the objective aperture to create a right-eye view of the specimen. In a second mode of operation, light from illuminator 12 is directed along the same optical path and only passes light through a different (including overlapping) portion of the objective aperture to create a left-eye view of the specimen.

As used herein portions of the area of an aperture are considered different even if they contain some common areas.

Those skilled in the art will recognize that other devices for providing alternating lighting elements are possible to provide the same function as the illuminator 56 described above.

FIG. 4 shows a GUI that could be used to easily operate the system to produce automated real-time 3D movies. The GUI includes a way to select the camera and camera driver, to select a 3D display system, and to set up the file save settings.

By selecting “View Real-Time Stereo”, the light sources 61 and 62 are caused to rapidly alternate between left and right lighting configurations at the same speed that the video camera 21 records frames (such as 30 frames/sec, or 15 frames/sec, etc). The mask would be instructed to rotate at 15 rps and maintain sync with a video camera operating at 30 frames per second.

A major advantage of the present invention is the ability to automate a single camera system to produce 3D stereo images and real-time stereo 3D video that are perfectly registered to one another. This is a significant improvement compared to other systems that use two cameras, one dedicated to capturing the left-eye view and the other camera dedicated to capturing the right-eye view.

Of course, various changes, modifications and alterations in the teachings of the present invention may be contemplated by those skilled in the art without departing from the intended spirit and scope thereof. As such, it is intended that the present invention only be limited by the terms of the appended claims.

What is claimed is:

1. A method of creating 3D perception of a three-dimensional specimen using a microscope having a single objective lens with an objective aperture having an aperture area, a single camera having a frame rate and an illuminator that directs light along a path that includes the specimen, the objective aperture and the camera comprising:
creating a right-eye view of the specimen in the camera by limiting the light that passes through the objective aperture to less than the entire area of the objective aperture;
creating a left-eye view of the specimen in the camera by limiting the light that passes through the objective aperture to less than the entire area of the objective aperture which, in part at least, is a different area than that which creates the right-eye view;
alternatively creating left-eye views and right-eye views at a rate that is a function of the camera frame rate.

2. The method of claim 1 wherein the frame rate and the rate at which right-eye views and left-eye views are alternated are synchronized to be the same whereby every other frame of the camera records a right-eye view and the other frames record a left-eye view.

3. The method of claim 1 wherein the light that passes the objective aperture is limited by blocking a portion of the area of the aperture from passing light.

4. The method of claim 1 wherein the light that passes the objective aperture is limited by the illuminator sending a beam that only partially fills the objective aperture.

5. The method of claim 1 further comprising:
displaying the recorded views of the camera on a visual display device.

6. Microscope apparatus having a single objective lens with an objective aperture having an aperture area, a single camera having a frame rate for creating 3D perception of a three -dimensional specimen comprising:
an illumination system that, in a first mode, directs light along an optical path that includes the specimen, the objective aperture and the camera and only passes light through a portion of the objective aperture to create a right-eye view of the specimen and, in a second mode, directs light along a path that includes the specimen, the objective aperture and the camera and only passes light through a different portion of the objective aperture to create a left-eye view of the specimen.

7. The microscope apparatus of claim 6 wherein said illumination system further comprises a mechanical mask disposed in the optical path which, during a segment of its rotation blocks a portion of the light from passing through the objective aperture to create a right-eye view of the specimen and, during another segment of its rotation, blocks a different portion of the light from passing through the objective aperture to create a left-eye view.

8. The microscope apparatus of claim 7 wherein said mechanical mask comprises a rotatable opaque disk disposed in a plane generally perpendicular to the optical path including facing arcuate slots through which light can pass.

9. The microscope apparatus of claim 6 wherein said illumination system comprises an illuminator that has a first mode in which it produces a beam that only fills a portion of the objective aperture to create a right-eye view of the specimen and a second mode in which it produces a beam that only fills a different portion of the objective aperture to create a left-eye view of the specimen.

10. The microscope apparatus of claim 9 wherein said illuminator comprises:
a first mirror surface and a second mirror surface;
a first light disposed to direct a first light beam onto said first mirror surface and onto the objective aperture and fill only a portion of the aperture to create a right-eye view;
a second light disposed to direct a second light beam onto said second mirror surface and onto the objective aperture and fill only a portion of the aperture different than the portion filled by said first light beam to create a left-eye view.

11. The microscope apparatus of claim 7 further comprising:
a sync generator that creates a signal by which said first and second lights alternate left-eye and right-eye views at the same rate as the frame rate of the camera.

12. The microscope apparatus of claim 6 further comprising:
a sync generator that creates a signal by which said mask rotates at a rate that at which alternate left-eye and right-eye views are created at the same rate as the frame rate of the camera.
